(19) United States
(12) Patent Application Publication
(10) Pub. No.: US 2003/0179293 A1
(43) Pub. Date: Sep. 25, 2003

(54) Vehicular image processing apparatus and vehicular image processing method

(75) Inventor: Ken Oizumi, Tokyo (JP)

Correspondence Address: McDERMOTT, WILL & EMERY, 600 13th Street, N.W., Washington, DC, 20005-3096, US

(73) Assignee: NISSAN MOTOR CO., LTD.

(21) Appl. No.: 10/355,151

(22) Filed: Jan. 31, 2003

(30) Foreign Application Priority Data
Mar. 22, 2002 (JP) P 2002-079970

(51) Int. Cl. H04N 7/18

(52) U.S. Cl. 348/148; 348/149

(57) ABSTRACT

An apparatus and a method of processing vehicular image are disclosed having a shift position acquisition unit 102, a plurality of cameras mounted on a vehicle to pickup surroundings of the vehicle, a plane view image preparing Unit 101 that converts pickup images pick up with the cameras, such that angles of reflection to interiors of the cameras are less than angles of incidence from outsides of the cameras, to prepare plane view images, an image processing unit 104 synthesizing the plurality of images into a single image, an image display unit 105 displaying a synthesized image, a figure indicative of the vehicle and a figure indicative of a direction in which the vehicle travels, and a display mode setting unit 103 operative to set a display mode of the image display unit 105.

### BACKGROUND OF THE INVENTION

The present invention relates to a vehicular image processing apparatus and a related method and, more particularly, to a vehicular image processing apparatus and a related method wherein images picked up with a plurality of image pickup sections mounted in a vehicle are converted into respective images as overlooked from a viewpoint position determined at an upper area of the vehicle.

Recently, apparatuses for supporting safety drives of vehicles have come in practice and are widely applied to the vehicles each of which is mounted with a plurality of cameras (electronic type cameras) to pick up images of and monitor surroundings of the vehicle.

Since a vehicular image processing apparatus and a related method, described in Japanese Patent Application Laid-Open No. 2001-339716, provide an ease of driving operation by dynamically altering a viewpoint position to eliminate a dead angle as viewed from a driver, an optimum synthesized image is displayed over a display unit, located inside the vehicle, depending on a driving status.

### SUMMARY OF THE INVENTION

When parking the vehicle in a parking lot using the related art set forth above, the driver drives the vehicle in repeated operations of a forward travel and a rearward travel of the vehicle while looking at the display screen of the display unit in which entire surroundings of the vehicle are displayed in a way to allow a front area of the vehicle is oriented upward. In this case, the driver undergoes a difficulty in grasping a relational correspondence between a direction in which an actual vehicle travels and a direction in which a vehicle displayed in the display screen travels.

It is an object of the present invention to solve the issue set forth above and provide a vehicular image processing apparatus and a related method which are able to provide an ease of grasping a relational correspondence between a direction in which an actual vehicle travels and a direction in which a vehicle displayed in the display screen travels.

To achieve the above object, a vehicular image processing apparatus of the present invention comprises a plurality of image pickup sections mounted in a vehicle to pickup images of surroundings of the vehicle with the pickup images being outputted, an image converting section converting the pickup images picked up by the image pickup sections such that angles of reflection inside the image pickup sections are less than angles of incidence outside the image pickup sections, a viewpoint converting section permitting images-converted-from-images, converted by the image converting section, to be converted in terms of viewpoint, an image synthesizing section synthesizing a plurality of images-converted-in-viewpoint that are converted in terms of the viewpoint by the viewpoint converting section, and a display section displaying the synthesized image, a figure indicative of the vehicle and a figure indicative of a direction in which the vehicle travels.

Further, the present invention provides a method of processing a vehicular image, comprising picking up images of surroundings of a vehicle by a plurality of image pickup sections mounted in the vehicle, converting the pickup images such that angles of reflection inside the image pickup sections are less than angles of reflection outside the image pickup sections, respectively, converting the converted images in terms of viewpoints, respectively, synthesizing a plurality of images-converted-in-viewpoint that are converted in terms of the viewpoints, and displaying a synthesized image, a figure indicative of the vehicle, and a figure indicative of a direction in which the vehicle travels.

### BRIEF DESCRIPTION OF THE DRAWINGS

FIG. 1 is a block diagram illustrating a structural example of a vehicular image processing apparatus of an embodiment according to the present invention.

FIG. 2 is a view illustrating an example of a display screen of an image display unit shown in FIG. 1.

FIG. 3 is a view illustrating another example of a display screen of the image display unit shown in FIG. 1.

FIG. 4 is a block diagram illustrating a viewpoint converting unit according to the present invention.

FIG. 5 is a view illustrating about an image conversion to be executed by an image converting means of the viewpoint converting unit shown in FIG. 4.

FIG. 6 is a view illustrating about an image conversion to be executed by the image converting means of the viewpoint converting unit shown in FIG. 4.

FIG. 7 is a view illustrating about a viewpoint conversion to be executed by a viewpoint converting means of the viewpoint converting unit shown in FIG. 4.

### DETAILED DESCRIPTION OF THE PREFERRED EMBODIMENS

Reference is now made in detail to an embodiment of the present invention which is illustrated in the accompanying drawings. In the following description of the embodiment with reference to the drawings, component parts having the same functions are given the same reference numerals and repetitive redundant descriptions of the same parts are omitted.

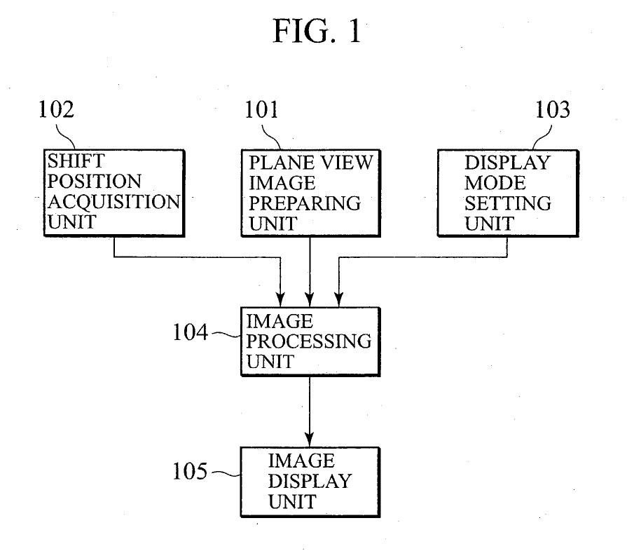

Referring to FIG. 1, it shows a block diagram of an exemplary structure of a vehicular image processing apparatus of an embodiment according to the present invention.

The vehicular image processing apparatus is comprised of a plane view image preparing unit 101, a shift position acquisition unit 102, a display mode setting unit 103, an image processing unit 104 and an image display unit (such as a monitor) 105.

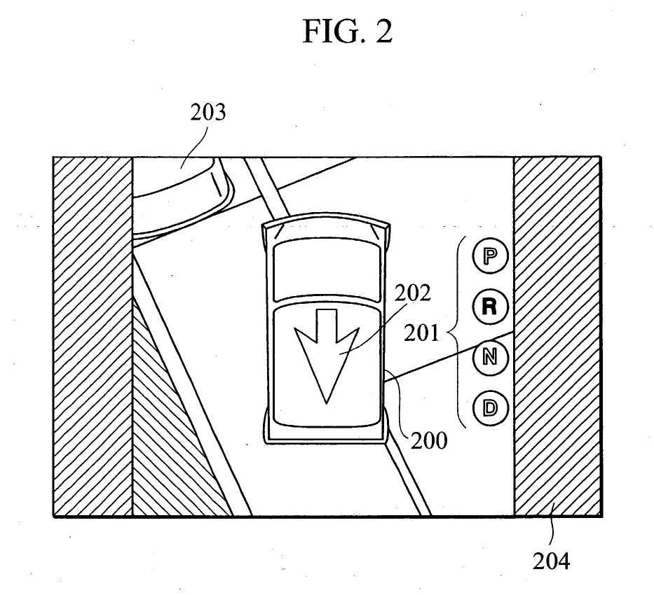

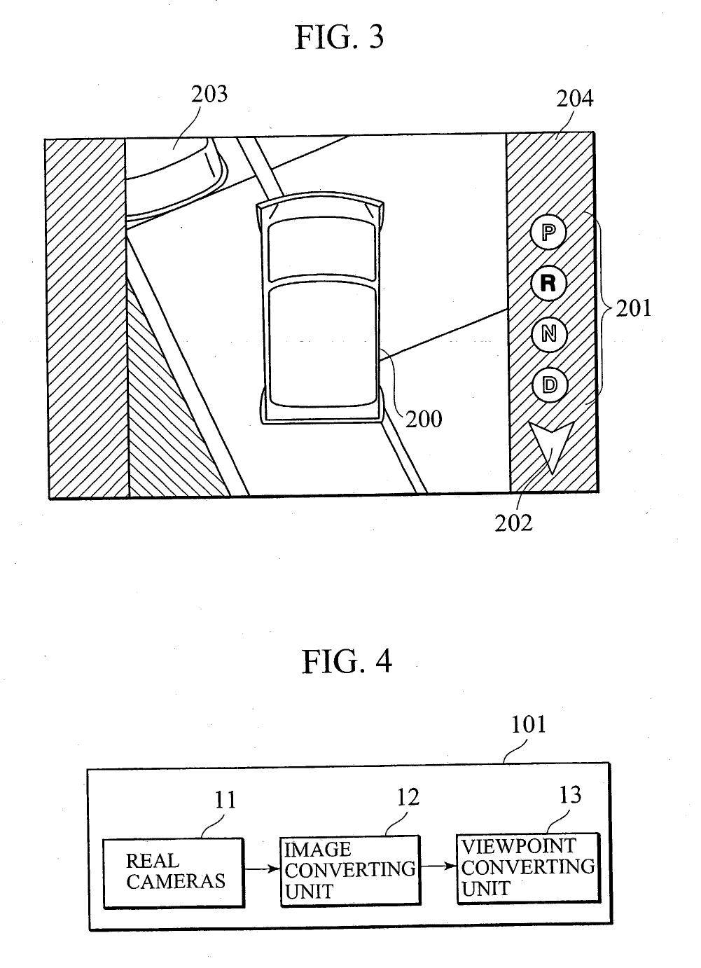

FIGS. 2 and 3 are views illustrating display screens of the image display unit 105, respectively, and indicative of displays of entire surroundings of vehicles including obstacles in the vicinities of the vehicles.

Reference numeral 200 designates a figure representing the vehicle. Here, the vehicle is shown as including an example of a wagon vehicle, with an upper area of the FIG. 200 indicative of the vehicle representing a front area of the vehicle. Reference numeral 201 designates a display (an image indicative of a shift status of the vehicle) of a shift indicator, 202 a figure showing a direction in which the vehicle travels, 203 an obstacle such as a preceding vehicle, and 204 an area located outside the display area. The FIG. 200 indicative of the vehicle and the FIG. 202 indicative of the direction in which the vehicle travels are not limited in respective fixed views in display and may be comprised of images varying in display.

The plane view image preparing unit 101 acquires images from cameras (not shown in the drawing) mounted on the vehicle and, as shown in FIGS. 2 and 3, prepares plane view images (images in a plane) as overhead viewing with different samples in display being shown in FIGS. 2 and 3, respectively. Also, a sequence of concretely preparing the plane images and a concrete structure of the plane image preparing unit 101 are described below in detail.

It is supposed that in a case where as long as the images prepared by the plane image preparing unit 101 of FIG. 1 are displayed over the display screen of the image display unit 105, the front area of the vehicle represented by the FIG. 200, indicative of the vehicle, is oriented upward. Hereinafter, in connection with the FIG. 200 indicative of the vehicle, the expressions “upward” and “downward” refer to a case where the front area of the vehicle displayed in the display screen is oriented upward and a case where the front area of the vehicle displayed in the display screen is oriented downward, respectively.

A driver of the vehicle is able to set a display mode for the plane images in dependence on a status of the vehicle using the display mode setting unit 103. In particular, the setting can be made such that with a vehicle incorporating an automatic power transmission, if a shift selector remains in a D (Drive) range, operation is executed to provide a display (a display of the image as outputted by the plane view image preparing unit 101 as set forth above) in which the front area of the vehicle is oriented upward whereas if the shift selector remains in a R (Reverse) range, operation is executed to provide a display (a display in which the image outputted by the plane view image preparing unit 101 is turned over up and down) in which the front area of the vehicle is oriented downward.

The driver is able to set for the display image to be turned over up and down, right and left, and up and down as well as right and left in dependence on the shift selector remaining in the D, R, P (Parking) and N (Neutral), respectively. Or, the driver is able to select not to display the image per se. Such setting remarkably depends on the driver's taste and, hence, the display mode is enabled to be freely set.

Also, with a vehicle equipped with a manual transmission, it is arranged such that a display method can be set in three modes, i.e., a forward drive gear ratio (1 to 6 gear ratios), Neutral and Reverse, in place of the D, R, P and N ranges employed in the vehicle equipped with the automatic power transmission. The display mode setting unit 103 may be comprised of a switch, a touch panel or a combination of a joystick and buttons.

Operational modes set by the driver is stored in a readable memory (not shown) of the image processing unit 104. Contents stored in the memory are retained until relevant data is newly updated by the driver. Depending on the shift position acquired by the shift position acquisition unit 102, the preset operational mode is automatically selected and read out to permit the image processing unit 104 to perform a preset image processing (to cause the image to be turned over up and down, right and left, and up and down as well as right and left, or to cause the image to remain unchanged) for the images prepared by the plane view image preparing unit 101. Or, more simply, an alternative way may be such that the display mode setting unit 103 is comprised of two components, i.e., an upward and downward turn-over switch and a right and left turn-over switch to allow the driver to manipulate these switches if desired.

Further, the image processing unit 104 pictures an image from which it turns out of which gear currently remains in the vehicle, i.e., the display 201 (see FIGS. 2 and 3) of the shift indicator indicative of an image representing the shift status of the vehicle. In this case, the image processing unit 104 pictures the shift indicator display in a form in which the shift indicator display is superimposed with the plane image (see FIG. 2) or in a form (as schematically shown in FIG. 3) in which the shift indicator display is provided in the vicinity of the display screen by means of various display means except for the display screen of the image display unit 105. This picture may include the shift indicator displays 201 shown in FIGS. 2 and 3 or may be comprised of a structure that is simple to some extent to allow the driver to understand a forward/rearward drive status. In general, this picturing is performed subsequent to the image turn-over processing set forth above.

Further, independently of such operation, in order for the driver to understand in image which of directions the vehicle travels when the driver depresses an accelerator pedal, the driver releases a brake or the driver steers a steering handle, the image processing unit 104 pictures FIGS. 202 in the Form of arrows (or triangles) as shown in FIGS. 2 and 3, respectively, to designate the direction in which the vehicle travels in a way to be superimposed on the FIG. 200 indicative of the vehicle within the displayed image (see FIG. 2). The FIG. 202 indicative of the direction in which the vehicle travels may be pictured in the vicinity of the display screen by means of various display means other than that of the display screen of the image display unit 105 like the display 201 of the shift indicator (see FIG. 3). While, in FIGS. 2 and 3, the picture of the display 201 of the shift indicator and the picture of the FIG. 202 indicative of the direction in which the vehicle travels are provided in the same area (i.e., within the same image display area in FIG. 2 and within the same display area 204 outside the image display area in FIG. 3), of course, the display 201 of the shift indicator may be pictured within the image display area and the FIG. 202 indicative of the direction in which the vehicle travels may be pictured in an area outside the image display area. Or, on the contrary, the FIG. 202 indicative of the direction in which the vehicle travels may be pictured in the image display area and the display 201 of the shift indicator may be pictured in the area outside the image display area. Further, in a case where a side brake is pulled up and the shift selector remains in one of the gear, N (Neutral) and parking (Parking) ranges, it shows that the vehicle stands halt and, hence, the FIG. 202 indicative of the direction in which the vehicle travels may not be pictured. The FIG. 201 of the shift indicator and the picturing, non-picturing and a position, at which the FIG. 202 indicative of the direction in which the vehicle travels, is pictured may be set in a menu of the display mode setting unit 103, or switches allocated with respective functions may be provided for manipulation by the driver on demand.

With such a manner stated above, a complete image, that is synthesized and pictured in the image processing unit 104, is displayed over the display screen of the image display unit 105 to be provided for the driver.

Thus, the presently filed embodiment has the features that the provision of the vehicular image processing apparatus and method in which a plurality of images picked up by a plurality of cameras mounted on the vehicle are converted into respective images as overlooked from a viewpoint preset in an upper area of the vehicle and the plurality of converted images are synthesized into one image for display over the display screen of the image display unit 105, for thereby allowing the FIG. 202 indicative of the direction in which the vehicle travels to be displayed such that the driver easily recognizes the direction, in which the vehicle travels, displayed in the display screen.

Now, a mechanism for enabling selection of the images, in the manner set forth above, to be displayed when the driver drives the vehicle rearward is described below.

When the display unit displays the vehicle and entire surroundings thereof in order to allow the driver to select the image to be displayed during the rearward drive of the vehicle, there is a method in that “the front area of the vehicle is displayed to be oriented upward in the display” and, in a case where the vehicle travels forward, almost no drivers have a sense of incompatibility in such a display method.

However, in a case where the vehicle travels rearward, if the image is displayed with no change in such a display method, some of the drivers have the sense of incompatibility. Such drivers prefer a display method in that, in order for a rearward scene to be viewed as being reflected on a room mirror or a side mirror, the previous image displayed during the forward travel of the vehicle is turned over up and down to provide “a display of the front area of the vehicle in a form oriented downward”, or prefer a display method in that, as viewed in a scene when the driver looks at a backward, the previous image displayed during the forward travel of the vehicle is turned over up and down as well as right and left to provide “a display of the front area of the vehicle in a form oriented downward”.

With the vehicular image processing apparatus of the presently filed structure, the driver is able to select the image, which is displayed during the rearward drive of the vehicle, to be provided so as to suit own taste, resulting in a capability of eliminating a load to be exerted to the driver during the driving operation.

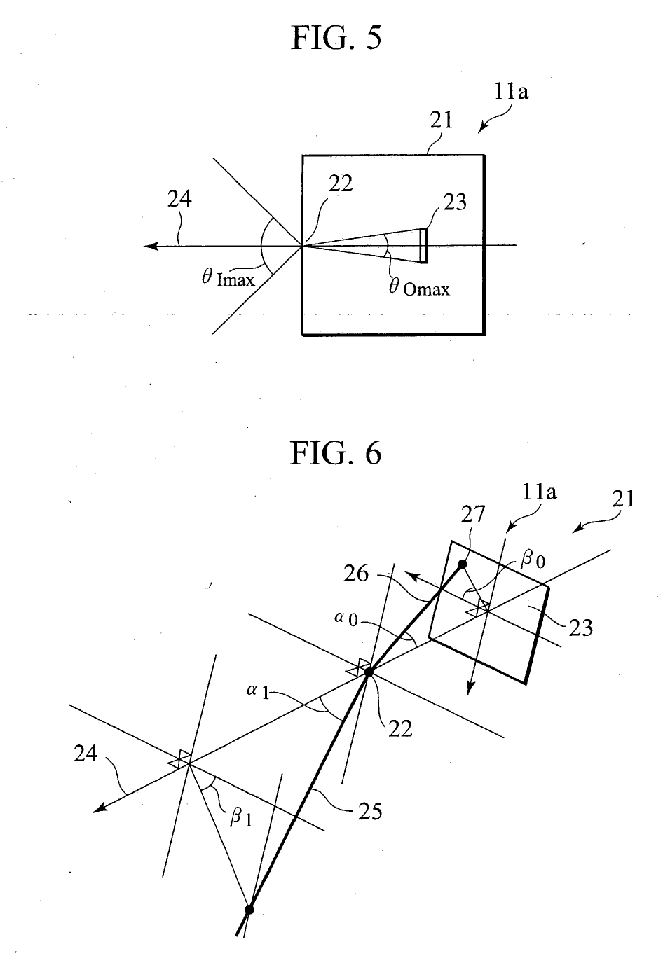

FIG. 4 is a block diagram illustrating a concrete structure of the plane view image preparing unit 101 shown in FIG. 1. As shown in the drawing, the vehicular image processing apparatus of the presently filed, embodiment is comprised of real cameras (image pickup sections) 11 picking up images, an image converting section 12 that converts pickup images picked up by the real cameras 11 into images wherein an angle of reflection of light incident inside the real camera 11 (exactly, a real camera model 11a shown in FIGS. 5 and 6) is made less than an angle of incidence of light incident outside the real camera 11 (the real cameral model 11a), and a viewpoint converting section 13 that converts the images-converted-from-images, which result from the image converting section 12, in terms of a viewpoint. Also, in FIG. 4, although only a single real cameral 11 has been shown, in an actual practice, the presently filed embodiment includes a plurality of real cameras 11 to pickup images of the surroundings of the vehicle (though not shown). A plurality of images-converted-in-viewpoint, converted in terms of the viewpoint by the view point converting section 13 of FIG. 4, are synthesized into one image by the image processing unit 104 of FIG. 1, with the synthesized image being displayed over the image display unit 105.

Next, a reference is made to FIGS. 5 and 6 to describe an image conversion mechanism of the image converting section 12 of the plane view image preparing unit 101 shown in FIG. 4. As shown in the drawings, with the pickup image picked up by the real camera 11, a light ray 25 (see FIG. 6) incident to the real cameral model 11a surely passes across a representative point 22 (in many frequencies to be used as a focal point or a central point of a lens), and a light ray 26 (see FIG. 6), which has passed across the representative point 22 and is incident to a camera body 21, impinges upon a pickup image surface 23 located inside the camera body 21. The image pickup surface 23 is disposed in a plane perpendicular to a camera light axis 24 indicative of a direction of the real camera model 11a (the real camera 11) and has a center through which the camera light axis 24 travels. Of course, depending on characteristics of the real camera 11 that is an object to be simulated, there may be instances where the camera light axis 24 does not necessarily pass through the center of the image pickup surface 23, and the image pickup surface 23 and the camera light axis 24 may be out of perpendicular relationship. Also, when simulating a CCD camera, the image pickup surface 23 is divided into a plurality of picture elements in a lattice form so as to realize the number of picture elements of the real camera 11 for the object to be simulated. Finally, since simulation is executed to find out which of the positions (the picture elements) of the pickup image 23 is incident with the light ray 26, only an issue arises in a distance between the representative point 22 and the pickup image surface 23 and a ratio between longitudinal and lateral length of the pickup image surface 23, with no issue arising in a real distance. For this reason, the distance between the representative point 22 and the pickup image surface 23 may be dealt with a unit distance (1) for convenience in calculation.

And, the image converting section 12 executes conversion in the image picked up by the real camera 11 such that the angles α₀, β₀ (with the angle α₀ of reflection forming an angle of the light ray 26 relative to the camera light axis 24 and the angle β₀ of reflection forming an angle of the light ray 26 relative to an axis perpendicular to the camera light axis 24) of reflection are made less than the angles α₁, β₁ (with the angle α₁ of incidence forming an angle of the light ray 25 relative to the camera light axis 24 and the angle β₁ of incidence forming an angle of the light ray 25 relative to an axis perpendicular to the camera light axis 24) of incidence of the light ray 25 incident outside the camera body 21 of the real camera model 11a.

Namely, the light ray 25 certainly passes across the representative point 22. Accordingly, using a polar coordinate system, the light ray 25 can be expressed in two angles, i.e., the angles α₁, β₁ of incidence based on the original point made of the representative point 22, and when the light ray 25 passes across the representative point 22, the light ray 25 becomes the light ray 26 with the angles α₀, β₀ of reflection being determined in the following formula:

α₀=f₁(α₁), β₀=f₂(β₁) (1)

In the above formula, it is arranged such that the relational formula of a α₀<α₁ is always satisfied. In this case, when the light ray 25 passes across the representative point 22, the light ray 25 is deflected in direction by the formula (1) to permit the light ray 26 to intersects the pickup image surface 23 at an intersecting point 27. When simulating with the use of the CCD camera, it is possible to obtain which of the picture elements on the pickup image surface 23 is incident with the light ray 26 coming from the coordinate (position) of the intersecting point 27.

Also, there are some instances where depending on the setting of the pickup image surface 23, the light ray 26 does not intersect the pickup image surface 23 and, in such instances, the light ray 25 is not reflected on the real camera model 11a.

Further, in a case where the maximum picture angle of the real camera 11 for the object to be simulated is supposed to be M (degrees), the light ray 25 available to be incident to the interior of the camera body 21 should satisfy the relation α₁<(M/2). The light ray 25, which does not satisfy such a condition, is not reflected on the real camera model 11a. When this occurs, the maximum value of the angle α₀ of reflection is calculated by f (M/2). Also, upon determination of functions f₁(α₁) and f₂(β₁) of the formula (1), the distance between the representative point 22 and the pickup image surface 23 and the longitudinal and lateral length of the pickup image surface are determined, thereby specifying a pickup range of the real cameral model 11a. Also, as shown in FIG. 5, the magnitude of the maximum angle θ_{0MAX} of reflection is less than the maximum angle θ_{1MAX} of incidence.

With the sequence set forth above, it is possible to calculate which of the picture elements (positions) on the pickup image surface 23 of the real camera model 11a is incident with the light ray 25 passing across the representative point 22. That is, the pickup image picked up by the real camera 11, i.e., the pickup image formed when the light ray 25 advances straight acrossing the representative point 22, is converted in image by the above described mechanism to obtain the images-converted-from-images. Accordingly, it is possible to calculate the relationship between the angles α₁ and β₁ of incidence of the light ray incident to the real camera 11 (the real cameral model 11a) and the picture element (position) of the images-converted-from-images as expressed in the formula (1).

Further, on the contrary, it is possible to calculate which of the directions the light ray 26, that passes across an arbitrary point on the pickup image surface 23 of the real camera model 11a, is incident to the representative point 22, in the following formula.

α₁=g₁(α₀), β₁=g₂(β₀) (2)

The simplest example of the formula (1) includes the following formula wherein the angles or α₁, β₁ of incidence and the angles α₀, β₀ of reflection have a proportionality relation as follows:

α₀=kα₁, β₀=kβ₁. (3)

where k represents a parameter by which the lens characteristics of the real camera model 11a are determined and is expressed as k<1. In case of k=1, the real camera model 11a takes the same operation as experienced in the related art pin-hole cameral model. Although a distortion characteristic of an actual lens depends on an object (a design intent) of the lens, a normal wide-range lens has an approximated distortion characteristic by suitably selecting the parameter k in a range of 1<k<0, resulting in a capability of providing a camera simulation to be performed at a higher precision than a camera simulation using the pin-hole camera model.

Further, when desired to perform the lens simulation in a further precise manner, the image is converted with no proportionality relation in the functions f₁(α₁), f₂(β₁) as expressed in the formula (3) and, instead thereof, the lens characteristics of the real camera 11 are actually measured to permit the image to be converted using the functions indicative of the lens characteristics of the real camera 11. In this case, of course, the angle α₀ of reflection is made less than the angle α₁ of incidence.

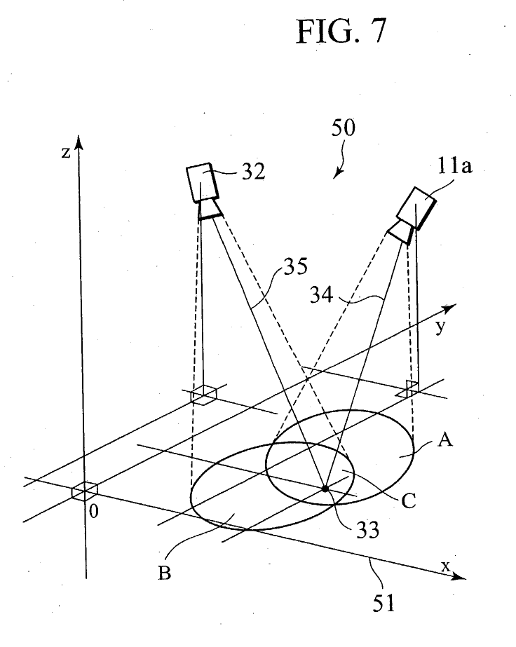

Subsequent to the operation to convert the image in the above-described manner, operation is executed to convert the image in terms of the viewpoint. The simplest viewpoint-conversion is realized by locating the real camera model, corresponding to the real camera, in a virtual space while setting a projected surface, and projecting the above-described image-converted-to-image of the image picked up by the real camera 11 onto the projected surface of the virtual space via the real camera model 11a (as indicated at an area A in FIG. 7 which will be described below).

Now, the viewpoint-conversion mechanism of the viewpoint converting section 13 of the plane view image preparing unit 101 of the presently filed embodiment shown in FIG. 4 is described below with reference to FIG. 7.

Referring to FIG. 7, an area A represents a projected area for the projected surface to which the images-converted-from-images, converted in image as described above, is projected via the real camera model 11a. An area B represents a projected area for the projected surface to which a visual field is projected via a viewpoint camera model 32 indicative of the viewpoint of the driver. An area C represents an overlapped area (C=A∩B) between the area A and the area B.

First, the virtual space 50 is set in compliance with an actual space, and the real camera model 11a corresponding to the real camera 11 and the viewpoint camera model 32 corresponding to the driver's visual field are located in a virtual coordinate system 51 prepared on the virtual space 50. When this takes place, the real camera model 11a and the viewpoint camera model 32 are located on the virtual coordinate system 51 in compliance with the position and the direction, in which the real camera 11 is located in the actual space, and the position of the driver (the vehicle) on the actual space and the driver's viewpoint (the direction). Subsequently, the projected surface is set. While, in the example shown in FIG. 7, an xy-plane has been shown as being placed on the projected surface, a plurality of other projected surfaces, such as a yz-plane or a zx-plane, may be provided in compliance with a topography of the actual space and the presence of an object. Next, a certain picture element V of the viewpoint camera model 32 is focused. The picture element V of the viewpoint camera model 32 has a surface area, and the coordinate of the central point of the picture element V is assigned as a representative coordinate. When this takes place, an intersecting point 33 is fixed on the projected surface of the picture element V in accordance with the position and the direction in which the viewpoint camera model 32 is set. Also, here, such a corresponding relationship is represented by a light ray 35 for convenience's sale. Similarly, the corresponding relationship between the intersecting point 33 and the picture element of the real camera model 11a is represented by a light ray 34 for convenience's sake. Next, let's consider the light ray 34 between the intersecting point 33 and the real camera model 11a. When this takes place, in a case where the light ray 34 is incident to the real camera model 11a (the real camera 11) at an area within a pickup range of the real camera 11 (that is, when the intersecting point 33 belongs to the area C), operation is executed to calculate which of the picture elements of the real camera model 11a is incident with the light ray 34. Namely, it is possible to calculate which of the picture elements of the real camera model 11a is incident with the light ray 34 for the images-converted-from-images appearing after the images have been converted as described in conjunction with FIGS. 5 and 6. Supposing that the picture element to which the light ray 34 is incident is a picture element R, the corresponding relationship between the picture element V and the picture element R is fixed and, hence, a color and brightness of the picture element V are able to be assigned with the color and brightness of the picture element R.

Also, in a case where the light ray 34 is incident to the real camera model 11a (the real camera 11) at the area outside the pickup range of the real camera 11 (that is, in a case where the intersecting point 33 belongs to the range (area B-area C) and in a case where no light ray 34 is incident to the pickup image surface of the real camera model 11a (the real camera 11) (that is, in a case where the intersecting point 33 belongs to the range (area B-area C), since the intersecting point 33 is not reflected on the real camera model 11a (the real camera 11) (that is, there is no presence of the picture element on the real camera model 11a corresponding to the intersecting point 33), it is supposed that, in this instance, no object is reflected on the picture element V of the viewpoint camera model 32. In this case, it is supposed that a default value (such as a black but, of course, the other color may be used) is used as the color of the picture element V.

Further, while, in the above example, the coordinate representative of the picture element V has been described in conjunction with one point (central point) for one picture element, a plurality of representative coordinates may be provided in the picture element V. In such a case, operation is implemented to calculate which of the picture elements of the real camera model 11a (the real camera 11) is incident with the light ray 34 for the representative coordinates, respectively, to permit a plurality of resulting colors and brightness to be blended to obtain the color and brightness of the picture element V. In this case, a blending ratio is equalized. Also, the colors and brightness's are blended in various techniques, such as an alpha blending process which forms a general method in a computer graphic field.

Carrying out the operations set forth above for all the picture elements of the viewpoint camera model 32 and determining the color and brightness of each picture element of the viewpoint camera model 32 enables the image of the viewpoint camera model, i.e., the image-converted-in-viewpoint, to be prepared. Thus, the image, converted from the image picked up by the real camera 11 in the actual space, i.e., the images-converted-from-images can be converted into the images-converted-in-viewpoint in terms of the viewpoint.

Such a process enables the characteristics and the position of the viewpoint camera model 32 to be freely settled as compared to the method in which the pickup image is simply projected over the projected surface and, therefore, it becomes possible to easily comply with the variations in the characteristics and positions of the viewpoint camera model 32. Thus, the area B shown in FIG. 7 is enabled to be arbitrarily settled.

Further, since each picture element of the viewpoint camera model 32 basically corresponds to the picture element of the real camera model 11a (the real camera 11) and no change occurs in such a correspondence unless change occurs in the positions, directions and the projected surfaces of the viewpoint camera model 32 and the real camera model 11a, when using the processing device with no allowance in a calculation capacity, a relational correspondence may be stored as a conversion table which in turn is referred to in executing the operations. Also, in a case where the viewpoint camera model 32 has a large number of picture elements, the larger the number of the picture elements of the viewpoint camera model 32, the larger will be the capacity of the conversion table in proportional relationship and it is advisable from a point of reduction in cost to use the processing device that enables the viewpoint-conversion to be calculated at a high speed rather than using a processing device (computer) having a memory with a large storage capacity.

With such a view-point conversion device since the variation in the position of the image pickup surface 23 and the variation in the angle α₀ of reflection are substantially the same with respect to one another in terms of the central portion and the contoured portion of the image pickup surface 23, it is possible to obtain the image-converted-in-viewpoint with less distortion from an image of the vicinity of the contoured portion and an image picked up by a camera with a large picture angle and, further, there is no need for picking up a pattern image to calculate a correction factor, enabling the conversion in terms of the viewpoint to be easily implemented. Also, when converting the image in terms of a factor in proportionate relationship between the angle α₀ of reflection and the angle α₁ of incidence, the central portion and the contoured portion are produced at the same magnification power in the images-converted-from-images that is converted in image, resulting in a capability of obtaining the images-converted-in-viewpoint with less distortion. Moreover, when converted in image with the factor indicative of the lens characteristic of the real camera 11, it is possible to obtain the image-converted-in-viewpoint with less distortion due to lens (aberration) of the real camera 11. Also, since the viewpoint converting section 13 provides the images-converted-in-viewpoint with each picture element in the same color and brightness as the color and brightness located at the central point of each color element of the images-converted-from-images, there is no need for calculating average values of the color and brightness, with a resultant reduction in the amount of calculation during the viewpoint converting operation.

Thus, the first aspect of the vehicular image processing apparatus of the presently filed embodiment features the provision of the plurality of image pickup means mounted on the vehicle and outputting the images picked up for the surroundings of the vehicle, the image converting section (as indicated at 12 in FIG. 4) that converts the pickup images, picked up by the image pickup means, into the image under a condition where the angle of reflection to the interior of the image pickup means is less than the angle of incidence of the light ray outside of the image pickup means, the viewpoint converting section (as indicated at 13 in FIG. 4) that converts the images-converted-from-images, resulting from the image pickup means, in terms of the viewpoint, the image synthesizing section (as indicated at the image processing unit 104 in FIG. 1) that synthesizes the plurality of the images-converted-in-viewpoint, that are converted in terms of the viewpoint by the viewpoint converting section, and the display section (as indicated as the image display unit 105 in FIG. 1) that provides the display of the synthesized image, the figure indicative of the vehicle and the figure indicative of the direction in which the vehicle travels. With such a structure, it is possible to obtain the images-converted-in-viewpoint with less distortion while providing a capability of easily converting the image in terms of the viewpoint and enabling the direction in which the vehicle travels to be clearly displayed in the screen, minimizing a load during the driving operation of the driver.

Further, the second aspect of the vehicular image processing apparatus of the presently filed embodiment concerns the vehicular image processing apparatus of the second aspect and features that the image converting section converts the image on the basis of the factor in proportion between the angle of reflection and the angle of incidence (see FIGS. 5 and 6). Such a structure enables the central portion and the contoured portion of the images-converted-from-images which is converted in image to have the same magnification power with a resultant capability of obtaining the image-converted-in-viewpoint with less distortion.

Further, the third aspect of the vehicular image processing apparatus of the presently filed embodiment concerns the vehicular image processing apparatus of the first aspect and features that the image converting section converts the image as the function of the lens characteristic of the image pickup means in terms of the angle of reflection and the angle of incidence. Such a structure enables the images-converted-in-viewpoint with less distortion due to the lens to be obtained.

Further the fourth aspect of the vehicular image processing apparatus of the presently filed embodiment concerns the vehicular image processing apparatus of the first aspect and features that the viewpoint converting section provides the images-converted-in-viewpoint with each picture element formed in the same color and brightness as the color and brightness located at the central point of each color element of the images-converted-from-images (see FIG. 7). With such a structure, there is no need for calculating average values of the color and brightness, with a resultant reduction in the amount of calculation during the viewpoint converting operation.

Furthermore, the fifth aspect of the vehicular image processing apparatus of the presently filed embodiment concerns the vehicular image processing apparatus of the first aspect and features the provision of the selecting section for selecting whether to provide the image which is different in the image displayed during the forward travel of the vehicle and the figure indicative of the direction in which the vehicle travels forward (see FIGS. 2 and 3) or to provide the image which is different in other aspects than the figure indicative of the direction in which the vehicle travels forward. Since such a structure enables the image to be provided which the driver tastes, the load to be exerted to the driver during the driving operation can be eliminated.

Further, the sixth aspect of the vehicular image processing apparatus of the presently filed embodiment concerns the vehicular image processing apparatus of the first aspect and features the provision of the change-over section for automatically changing over between the image displayed during the forward traveling direction of the vehicle and the image displayed during the rearward drive of the vehicle in response to the shift-change operation. Since such a structure provides no need for changing over between the image displayed during the forward traveling of the vehicle and the image displayed during the rearward drive of the vehicle and enables the images to be automatically changed over, the above-described structure is convenient and enables the load of the driver to be eliminated during the driving operation.

Furthermore, the seventh aspect of the vehicular image processing apparatus of the presently filed embodiment concerns the vehicular image processing apparatus of the fifth aspect and features that the image displayed during the withdrawal of the vehicle includes either the image which is different only in the image displayed during the forward traveling of the vehicle and the figure indicative of the forward traveling of the vehicle, the image composed of the image, displayed during the forward traveling of the vehicle, whose upper and lower edges are turned over or the image composed of the image, displayed during the forward traveling of the vehicle, whose upper and lower edges and right and left edges are turned over. Since such a structure enables the driver to view the image which the driver tastes, the load to be exerted to the driver during the driving operation can be eliminated.

Furthermore, the eighth aspect of the vehicular image processing apparatus of the presently filed embodiment concerns the vehicular image processing apparatus of the seventh aspect and features that the selecting section (the display mode setting unit 103 and the image processing unit 104 in FIG. 1) selects the image displayed during the rearward drive of the vehicle among the image which is different only in the image displayed during the forward traveling of the vehicle and the figure indicative of the forward traveling of the vehicle, the image composed of the image, displayed during the forward traveling of the vehicle, whose upper and lower edges are turned over and the image composed of the image, displayed during the forward traveling of the vehicle, whose upper and lower edges and right and left edges are turned over. Since such a structure enables the driver to select the image which the driver tastes, the load to be exerted to the driver during the driving operation can be eliminated.

Furthermore, the ninth aspect of the vehicular image processing apparatus of the presently filed embodiment concerns the vehicular image processing apparatus of the first aspect and features the provision of the display section (the shift position acquisition unit 102, the image processing unit 104 and the image display unit 105 in FIG. 1) which displays the image (the display 201 of the shift indicator in FIGS. 2 and 3) indicative of the shift status of the vehicle. Since such a structure enables the driver to be informed with the shift status during the driving operation of the vehicle, such a structure is convenient and is able to eliminate the load to be exerted to the driver during the driving operation.

Furthermore, the tenth aspect of the vehicular image processing apparatus of the presently filed embodiment concerns the vehicular image processing apparatus of the first aspect and features that the display section (the image processing unit 104 and the image display unit 105 in FIG. 1) provides a display of the figure indicative of the direction in which the vehicle travels on the displayed image (see FIG. 2) or in the vicinity of the displayed image to display which of the directions the vehicle travels in response to at least one operation of the accelerator pedal, the brake and the steering handle. Since such a structure enables the driver to easily know the direction, in which the vehicle travels, during the driving operation of the vehicle, such a structure is convenient and is able to eliminate the load to be exerted to the driver during the driving operation.

Furthermore, the eleventh aspect of the vehicular image processing apparatus of the presently filed embodiment concerns the vehicular image processing apparatus of the first aspect and features the provision of the display section (the image processing unit 104 and the image display unit 105 30 in FIG. 1) that displays the figure, indicative of the direction in which the vehicle travels, in an overlapped state with the figure indicative of the vehicle (see FIG. 2). Since such a structure allows the figure indicative of the direction in which the vehicle travels to be easily visible and is convenient, with a resultant reduction in load to be exerted to the driver during the driving operation.

Moreover, the tenth aspect of the presently filed embodiment concerns the vehicular image and features that a plurality of image pickup sections (the real camera 11 in FIG. 4) mounted to the vehicle pick up the images of the surroundings of the vehicle to allow the pickup images to be converted in image, such that the angles of reflection in the interior of the image pickup sections are selected to be less than the angles of incidence outside the image pickup sections, respectively, and to allow the images, which are converted in image, to be converted in terms of the viewpoint whereupon a plurality of images, that are converted in viewpoint, to be synthesized, with the synthesized image, the figure (as indicated as 200 in FIGS. 2 and 3) indicative of the vehicle (as indicated as 200 in FIGS. 2 and 3) and the figure (as indicated as 202 in FIGS. 2 and 3) indicative of the direction in which the vehicle travels. Since such a structure enables the images-converted-in-viewpoint with less distortion to be obtained and enables the image to be easily converted in viewpoint while allowing the direction, in which the vehicle travels, to be clearly displayed in the screen, the load to be exerted to the driver to be eliminated during the driving operation of the vehicle.

According to the present invention, as set forth above, there is provided the vehicular image processing apparatus that allows the driver to easily grasp the corresponding relationship between the direction in which the vehicle actually travels and the direction in which the vehicle, displayed in the display screen, travels.

The entire content of Japanese Patent Application No. P2002-79970 with a filing date of Mar. 22, 2002 is herein incorporated by reference.

Although the present invention has been described above by reference to certain embodiments of the invention, the invention is not limited to the embodiments described above and modifications will occur to those skilled in the art, in light of the teachings. The scope of the invention is defined with reference to the following claims.

What is claimed is:

1. A vehicular image processing apparatus comprising:
a plurality of image pickup sections mounted in a vehicle to pickup images of surroundings of the vehicle with the pickup images being outputted;
an image converting section converting the pickup images picked up by the image pickup sections such that angles of reflection inside the image pickup sections are less than angles of incidence outside the image pickup sections;
a viewpoint converting section permitting images-converted-from-images, converted by the image converting section, to be converted in terms of viewpoint;
an image synthesizing section synthesizing a plurality of images-converted-in-viewpoint that are converted in terms of the viewpoint by the viewpoint converting section; and
a display section displaying the synthesized image, a figure indicative of is the vehicle and a figure indicative of a direction in which the vehicle travels.

2. The vehicular image processing apparatus according to claim 1, wherein the viewpoint converting section converts the images as a proportionality function between the angle of reflection and the angle of incidence.

3. The vehicular image processing apparatus according to claim 1, wherein the image converting section converts the images as a function indicative of a lens characteristics of the image pickup sections in terms of the angle of reflection and the angle of incidence.

4. The vehicular image processing apparatus according to claim 1, wherein the viewpoint converting section allows each picture element of the viewpoint converting section to have a color and brightness in alignment with a color and brightness of a central point located at each picture element of the image-converted-to-image corresponding to each picture element of the image-converted-in-viewpoint.

5. The vehicular image processing apparatus according to claim 1, further comprising a selecting section selecting the image displayed during rearward drive of the vehicle from among the image which is different in the image displayed during forward traveling of the vehicle and the figure indicative of the forward traveling direction and the image which is different in other aspects than the figure indicative of the forward traveling direction.

6. The vehicular image processing apparatus according to claim 1, further comprising a change-over section automatically changing over between the image displayed during the forward traveling of the vehicle and the image displayed during the rearward drive of the vehicle in dependence on an operation of the shift change.

7. The vehicular image processing apparatus according to claim 5, wherein the image displayed during the rearward drive of the vehicle includes either an image which is different only in the image displayed during the forward traveling of the vehicle and the figure indicative of a forward traveling of the vehicle, an image composed of the image, displayed during the forward traveling of the vehicle, whose upper and lower edges are turned over or an image composed of the image, displayed during the forward traveling of the vehicle, whose upper and lower edges and right and left edges are turned over.

8. The vehicular image processing apparatus according to claim 7, wherein the selecting section selects the image displayed during the withdrawal of the vehicle from among the image which is different only in the image displayed during the forward traveling of the vehicle and the figure indicative of a forward traveling of the vehicle, the image composed of the image, displayed during the forward traveling of the vehicle, whose upper and lower edges are turned over and the image composed of the image, displayed during the forward traveling of the vehicle, whose upper and lower edges and right and left edges are turned over.

9. The vehicular image processing apparatus according to claim 1, wherein the display section displays an image, indicative of a shift status of the vehicle, at an area in the vicinity of the display screen.

10. The vehicular image processing apparatus according to claim 1, wherein the display section is responsive to at least one operation of an accelerator pedal, a brake and a steering wheel to display the figure, indicative of the direction in which the vehicle travels, on the display screen or at an area close proximity to the display screen to indicate which of the directions the vehicle travels in.

11. The vehicular image processing apparatus according to claim 1, wherein the display section displays the figure, indicative of the direction in which the vehicle travels, in a way to be overlapped with the figure indicative of the vehicle.

12. A method of processing a vehicular image, comprising:
picking up images of surroundings of a vehicle by a plurality of image pickup sections mounted in the vehicle;
converting the pickup images such that angles of reflection inside the image pickup sections are less than angles of reflection outside the image pickup sections, respectively;
converting the converted images in terms of viewpoints, respectively;
synthesizing a plurality of images-converted-in-viewpoint that are converted in terms of the viewpoints; and
displaying a synthesized image, a figure indicative of the vehicle, and a figure indicative of a direction in which the vehicle travels.

13. A vehicular image processing apparatus comprising:
a plurality of image pickup means mounted in a vehicle for outputting pickup images of surroundings of the vehicle;
image converting means for converting the pickup images, picked up by the image pickup means, such that angles of reflection inside the image pickup sections are less than angles of reflection outside the image pickup sections, respectively;
viewpoint converting means for converting images-converted-in-image, that are converted by the image converting means in terms of viewpoints;
image synthesizing means for synthesizing a plurality of images-converted-in-viewpoint that are converted by the viewpoint converting means in terms of the viewpoints; and
display means for displaying a synthesized image, a figure indicative of the vehicle, and a figure indicative of a direction in which the vehicle travels.
